(19) United States
(12) Patent Application Publication
(10) Pub. No.: US 2021/0201302 A1
(43) Pub. Date: Jul. 1, 2021

(54) Systems and Methods for Transmitting Electronic Currency

(71) Applicant: Cross River Bank, Fort Lee, NJ (US)

(72) Inventors: Jesse Honigberg, Valley Cottage, NY (US); Michael Raff, Monsey, NY (US); Uriel Natan Meir Ash, Spring Valley, NY (US)

(73) Assignee: Cross River Bank, Fort Lee, NJ (US)

(21) Appl. No.: 17/137,295

(22) Filed: Dec. 29, 2020

Related U.S. Application Data
(60) Provisional application No. 62/954,902, filed on Dec. 30, 2019.

(51) Int. Cl. G06Q 20/38; G06Q 20/06; G06Q 40/02; G06Q 20/40; G06F 9/54

(52) U.S. Cl. CPC G06Q 20/385; G06Q 20/0655; G06Q 20/027; G06Q 20/405; G06F 9/547; G06Q 40/02

(57) ABSTRACT

Embodiments of the present invention provide for systems and methods for transmitting electronic currency. The systems and methods provide for one or more processors for transmitting electronic currency from a first end device associated with a first electronic payment network to a second end device associated with a second electronic payment network, wherein the second payment network is different from the first payment network.

### CROSS-REFERENCE TO RELATED APPLICATION

This application claims the benefit of U.S. Provisional Patent Application No. 62/954,902, which was filed on Dec. 30, 2019 and is incorporated by reference in its entirety.

### FIELD OF THE INVENTION

The present disclosure relates to systems and method for transmitting electronic currency.

### BACKGROUND OF THE INVENTION

Electronic payment networks are used to transfer electronic currency between a variety of different digital accounts. The technology underlying these networks varies significantly in terms of capabilities, message specifications, connectivity requirements, and allowed membership. For example, certain networks only allow U.S.-based banks as participants (e.g., Fedwires), while other networks only allow for message interchange via closed-network application programming interfaces (APIs), e.g., real-time payments (RTP) network. The RTP network is a system that enables near-instantaneous electronic currency transfer between financial institutions. The RTP network can facilitate currency transfer across a number of payment categories, including, for example, business-to-business (B2B), business-to-consumer (B2C), consumer-to-business (C2B), peer-to-peer (P2P), government-to-citizen (G2C), and account-to-account (A2A) transactions. In this regard, in order for a financial institution to have access to the RTP network, the financial institution has to include the core network platform underlying the RTP network, e.g., closed-network APIs.

Accordingly, if the financial institution does not include the core network platform, it could not access the RTP network and, therefore, could not take advantage of the near-instantaneous electronic currency transfer.

As such, it would be desirable to have systems and methods that could overcome these and other deficiencies of known systems.

### SUMMARY OF THE INVENTION

Embodiments of the present invention relate to systems and methods for transmitting electronic currency.

According to an embodiment, a system for transmitting electronic currency can include: one or more processors, wherein the one or more processors are configured to: (i) receive an inbound message from a first end device associated with a first payment network, wherein the inbound message includes at least one of a source account, a destination account, and a desired amount of electronic currency to transmit; (ii) upon determining that the destination account is associated with a second payment network, create an alias account for the source account based on the second payment network, wherein the second payment network is different from the first payment network; (iii) apply one or more transformations to the inbound message to create an intermediate payment message, wherein the inbound message includes the alias account; (iv) generate one or more payment instructions for the intermediate payment message; and (v) execute the one or more payment instructions with the second payment network.

According to an embodiment, a method for transmitting electronic currency can include: (i) receiving, with one or more processors, an inbound message from a first end device associated with a first payment network, wherein the inbound message includes at least one of a source account, a destination account, and a desired amount of electronic currency to transmit; (ii) upon determining that the destination account is associated with a second payment network, creating, with the one or more processors, an alias account for the source account based on the second payment network, wherein the second payment network is different from the first payment network; (iii) applying, with the one or more processors, one or more transformations to the inbound message to create an intermediate payment message, wherein the inbound message includes the alias account; (iv) generating, with the one or more processors, one or more payment instructions for the intermediate payment message; and (v) executing, with the one or more processors, the one or more payment instructions with the second payment network.

According to an embodiment, the exemplary system provides for the transmission of electronic messages and/or currency from one payment network to another, distinct, network by creating a series of interoperability messages and database-driven rulesets to convert the message in the inbound format, transform it through a waterfall series of rulesets to an equivalent account (or series of accounts) across different payment platforms, and transmit the message to the applicable payment network via its specific format. The transformed message can be numerically identical to the original inbound payment (sum of inbound payments =sum of outbound payments) but distributed out to a series of different payment methods and settlements. In this regard, the exemplary system can support the inbound payment account number being a pseudonym for a real or virtual account on the outbound (settlement) network. The database ruleset further supports transformation of an account into a nominal equivalent. For example, an inbound account can be transformed into an outbound account, that is further transformed into a physical debit card number, that is further transformed into a tokenized card number to allow for posting to the debit push-to-card payment network. These waterfall transformations can enable a wide range of interoperability scenarios.

The interoperability messages and database rulesets ensure transactional integrity as well as manage differences that can arise between transformed messages. The unique combination of offering multi-protocol, multi-account transformation and settlement differentiates the exemplary system from current systems.

In this regard, embodiments of the present invention can provide the following advantages: (i) wide capabilities to allow for participants on one electronic payment network to move funds to another electronic payment network, e.g., through cascading logic that can assign an inbound payment to one or multiple accounts with different account numbers and settlement requirements, (ii) transactional integrity management through the use of nested settlement logic to ensure that inbound or outbound payments can be accepted, and that any transformations between networks or accounts remain in balance to the original electronic payment request, and (iii) exponential benefit with the addition of new payment networks to the system, e.g., (existing network+new network)^{(existing network+new network)}.

These and other advantages will be described more fully in the following detailed description.

### BRIEF DESCRIPTION OF THE DRAWINGS

Some aspects of the disclosure are herein described, by way of example only, with reference to the accompanying drawings. With specific reference now to the drawings in detail, it is stressed that the particulars shown are by way of example and are for purposes of illustrative discussion of embodiments of the disclosure. In this regard, the description, taken with the drawings, makes apparent to those skilled in the art how aspects of the disclosure may be practiced.

FIG. 1A depicts a system according to an exemplary embodiment of the invention.

FIG. 1B depicts a gateway network server according to an exemplary embodiment of the invention.

FIG. 1C depicts a first electronic payment network server according to an exemplary embodiment of the invention.

FIG. 1D depicts a second electronic payment network server according to an exemplary embodiment of the invention.

FIG. 2 depicts a flow diagram for the components in the system of FIG. 1 according to an exemplary embodiment of the invention.

FIG. 3 depicts a flow diagram for the components in the system of FIG. 1 according to another exemplary embodiment of the invention.

FIG. 4 depicts an interaction of the components in the system of FIG. 1 according to an exemplary embodiment of the invention.

### DETAILED DESCRIPTION

This description is not intended to be a detailed catalog of all the different ways in which the disclosure may be implemented, or all the features that may be added to the instant disclosure. For example, features illustrated with respect to one embodiment may be incorporated into other embodiments, and features illustrated with respect to a particular embodiment may be deleted from that embodiment. Thus, the disclosure contemplates that in some embodiments of the disclosure, any feature or combination of features set forth herein can be excluded or omitted. In addition, numerous variations and additions to the various embodiments suggested herein will be apparent to those skilled in the art in light of the instant disclosure, which do not depart from the instant disclosure. In other instances, well-known structures, interfaces, and processes have not been shown in detail in order not to unnecessarily obscure the invention. It is intended that no part of this specification be construed to affect a disavowal of any part of the full scope of the invention. Hence, the following descriptions are intended to illustrate some particular embodiments of the disclosure, and not to exhaustively specify all permutations, combinations and variations thereof.

Unless explicitly stated otherwise, the definition of any term herein is solely for identification and the reader's convenience; no such definition shall be taken to mean that any term is being given any meaning other than that commonly understood by one of ordinary skill in the art to which this disclosure belongs, unless the definition herein cannot reasonably be reconciled with that meaning. Further, in the absence of such explicit definition, all technical and scientific terms used herein have the same meaning as commonly understood by one of ordinary skill in the art to which this disclosure belongs. The terminology used in the description of the disclosure herein is for the purpose of describing particular embodiments only and is not intended to be limiting of the disclosure.

Unless the context indicates otherwise, it is specifically intended that the various features of the disclosure described herein can be used in any combination. Moreover, the present disclosure also contemplates that in some embodiments of the disclosure, any feature or combination of features set forth herein can be excluded or omitted.

The methods disclosed herein comprise one or more steps or actions for achieving the described method. The method steps and/or actions may be interchanged with one another without departing from the scope of the present invention. In other words, unless a specific order of steps or actions is required for proper operation of the embodiment, the order and/or use of specific steps and/or actions may be modified without departing from the scope of the present invention.

As used in the description of the disclosure and the appended claims, the singular forms “a”, “an”, and “the” are intended to include the plural forms as well, unless the context clearly indicates otherwise.

As used herein, “and/or” refers to and encompasses any and all possible combinations of one or more of the associated listed items, as well as the lack of combinations when interpreted in the alternative (“or”).

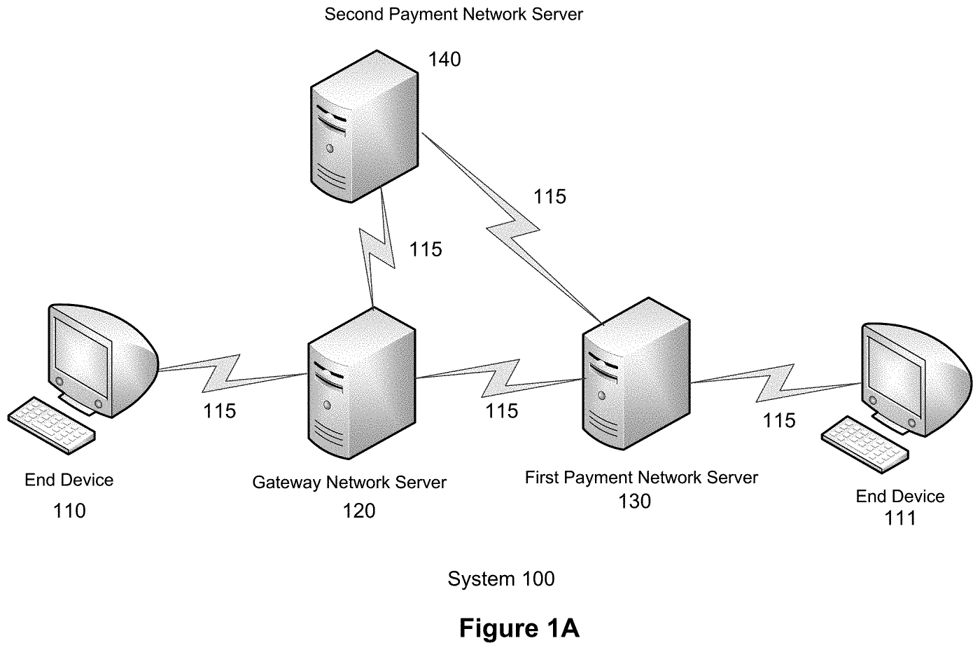

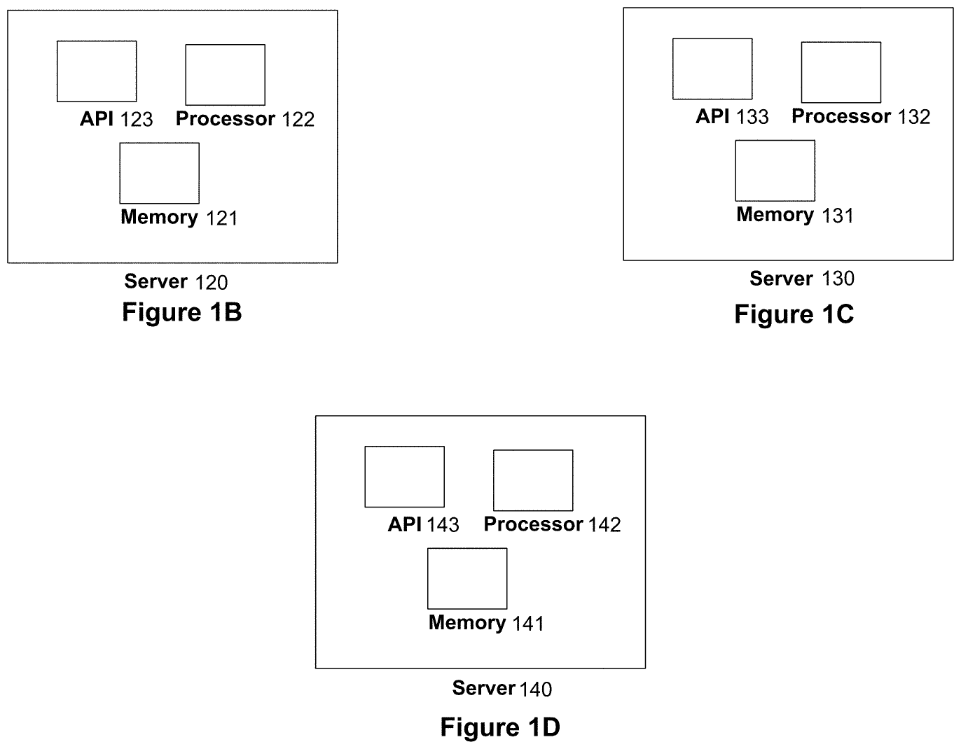

FIG. 1A depicts a system according to exemplary embodiment of the invention. As depicted in the figure, a system 100 includes end devices 110 and 111, a communication network 115, a gateway network server 120, a first electronic payment network server 130, and a second electronic payment network server 140. According to an embodiment, the end devices 110 and 111 can be one of personal computers, kiosks, tablets, mobile devices, etc. In this regard, the end devices 110 and 111 can include a display. According to an embodiment, the display can be a liquid crystal display (LCD), e.g., thin-film-transistor (TFT) LCD, in-place switching (IPS) LCD, capacitive or resistive touchscreen LCD, etc. Further, the display can also be an organic light emitting diode (OLED), e.g., active-matrix organic light emitting diode (AMOLED), super AMOLED, etc. Further, according to an embodiment, the end device 111 can include the core network platform underlying the first electronic payment network, e.g., the RTP network, while the end device 110 does not include the core network platform underlying the first electronic payment network. In this regard, the first electronic payment network can be a closed network that only allows for message interchange via corresponding closed-network APIs. In other words, the end device 111 can access the first electronic payment network directly via a corresponding closed network API, while the end device 110 cannot access it directly. In this regard, according to an embodiment, the end device 110 can access the first payment network indirectly via the gateway network server 120 and the first payment network server 130, which will be described in greater detail below. According to an embodiment, as depicted in FIGS. 1B-1D, the gateway network server 120, the first payment network server 130, and the second payment network server 140 each include a respective memory (e.g., memories 121, 131, and 141), processor (e.g., processor 122, 132, and 142), and a representational state transfer API (RESTful API) (e.g., APIs 123, 133, and 143). According to an embodiment, the respective memories 121, 131, and 141 can be used to store computer instructions and data including any and all forms of non-volatile memory, including semiconductor devices (e.g., SRAM, DRAM, EPROM, EEPROM, and flash memory devices), magnetic disks (e.g., internal hard disks or removable disks), magneto-optical disks, and CD-ROM and DVD-ROM disks. Further, the respective processors 122, 132, and 142 can be suitable for the execution of a computer program and can include both general and special purpose microprocessors, as well as any one or more processors of any kind of digital computer. Further, the respective processors 122, 132, and 142 can receive instructions and data from the memories 121, 131, and 141, e.g., to carry out at least part or all of the processes. Further, the respective APIs 123, 133, and 143 can be used to transmit relevant data. According to an embodiment, the respective APIs 123, 133, and 143 can receive and transmit relevant data, including messages, based on one of the following formats: Secure File Transfer protocol (SFTP), Simple Object Access Protocol (SOAP), JavaScript Object Notation (JSON), and Hypertext Transfer Protocol Secure (HTTPS) Web Post.

Further, according to an embodiment, the communications network 115 can include, or can interface to, at least one of the Internet, an intranet, a local area network (LAN), a wide area network (WAN), a metropolitan area network (MAN), a storage area network (SAN), a frame relay connection, an advanced intelligent network (AIN) connection, a synchronous optical network (SONET) connection, a digital T1, T3, E1 or E3 line, a digital data service (DDS) connection, a digital subscriber line (DSL) connection, an Ethernet connection, an integrated services digital network (ISDN) line, a dial-up port such as a V.90, a V.34 or a V.34 bis analog modem connection, a cable modem, an asynchronous transfer mode (ATM) connection, a fiber distributed data interface (FDDI) connection, a copper distributed data interface (CDDI) connection, or an optical/DWDM network. In another embodiment, the communications network 115 can include, or can interface to, at least one of wireless application protocol (WAP) link, a Wi-Fi link, a microwave link, a general packet radio service (GPRS) link, a global system for mobile Communication (GSM) link, a Code Division Multiple Access (CDMA) link or a time division multiple access (TDMA) link such as a cellular phone channel, a GPS link, a cellular digital packet data (CDPD) link, a Research in Motion, Limited (RIM) duplex paging type device, a Bluetooth radio link, or an IEEE 802.11-based radio frequency link. Further, in another embodiment, the communications network 115 can include, or can interface to, at least one of an RS-232 serial connection, an IEEE-1394 (FireWire) connection, a Fibre Channel connection, an infrared (IrDA) port, a small computer systems interface (SCSI) connection, a universal serial bus (USB) connection or another wired or wireless, digital or analog interface or connection.

Further, according to an embodiment, each of the gateway network server 120 and the first payment network server 130 can include the core network platform underlying the first payment network, e.g., closed-network APIs that can communicate with each other. In this regard, the end device 110 can indirectly access the first payment network by registering the end device 110 with the first payment network server 130 identifying the gateway network server 120 as its third-party service provider. After registering with the first payment network server 130, the end device 110 can periodically provide the gateway network server 120 an electronic data file including a plurality of account numbers and corresponding debit card numbers, card verification value (CVV) numbers, and expiration dates. Further, the account numbers can also be associated with the account holders' names and addresses. According to an embodiment, the electronic data file can be provided one or more times a day at a particular time(s). According to another embodiment, the electronic data file can be provided only after the electronic data file is modified, e.g., addition and/or removal of an account and/or account information. In this regard, the electronic data file can be generated and maintained at the end device 110. According to another embodiment, the electronic data file can be generated and maintained elsewhere, and retrieved by the end device 110 only when necessary. Further, according to an embodiment, after receiving the electronic data file, the gateway network server 120 can then tokenize and encrypt the account and debit card information within the electronic data file. According to another embodiment, the gateway network server 120 can store the data within the electronic data file as received.

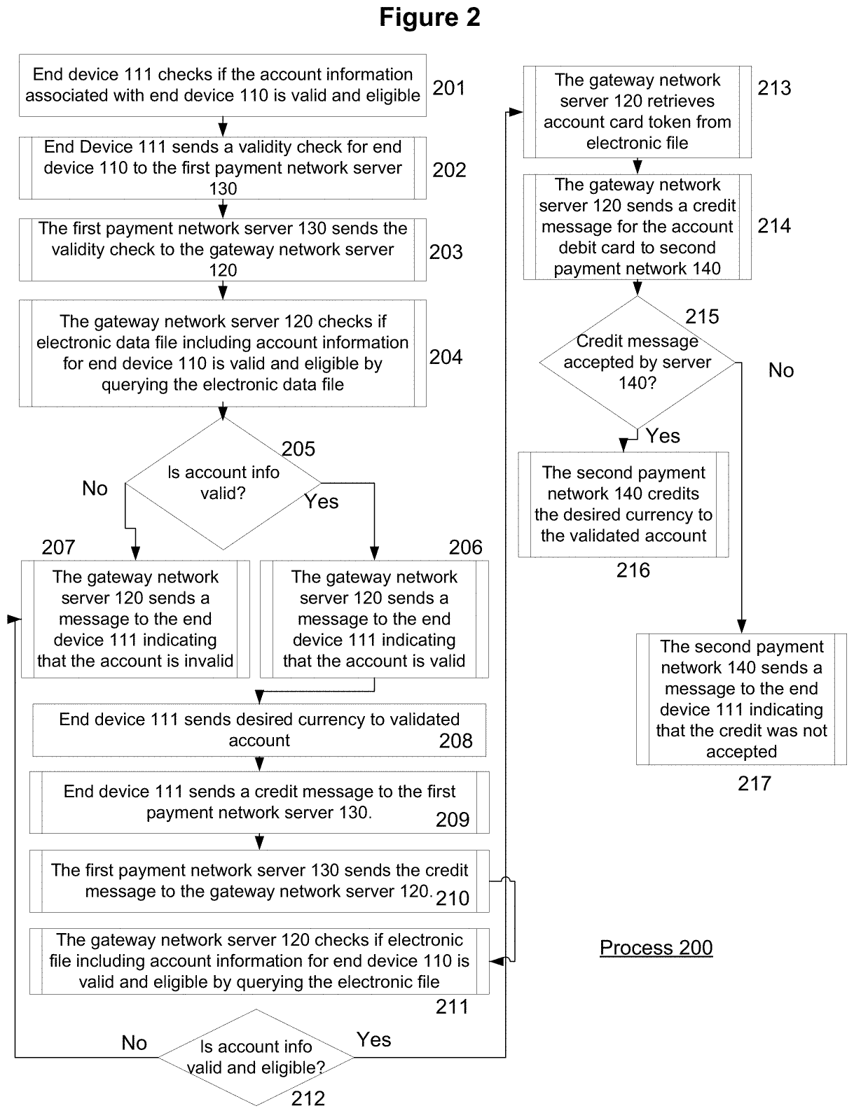

FIG. 2 depicts a flow diagram for the components in the system of FIG. 1 according to an exemplary embodiment of the invention. In particular, the figure depicts a process 200 for transmitting currency from the end device 111, which includes the core network platform underlying the first payment network, to the end device 110, which does not include the core network platform underlying the first payment network. According an embodiment, the end device 111 can be associated with an entity (e.g., consumer or business) with an account at a first financial institution, e.g., entity A, while the end device 110 can be associated with an entity (e.g., consumer or business) with an account at a second financial institution, e.g., entity B. As depicted in the figure, before entity A can send a desired amount of electronic currency, e.g., $100, to entity B, the end device 111 must first check if the account information associated with entity B (e.g., the end device 110) is valid and eligible. In order to do this, the end device 111 can send a validity check for the account information associated with the end device 110 to the first payment network server 130, as described in step 202. Then, as depicted in step 203, the first payment network server 130 can send, e.g., via the API 131, the validity check to the gateway network server 120. The gateway network server 120 then checks if the stored electronic data file including the account information for the end device 110 is valid and eligible by querying the stored electronic data file, as depicted in step 204. In particular, the gateway network server 120 checks if the account associated with entity B is actually included in the stored electronic data file. Then, in step 205, the gateway network server 120 determines if the account information is valid. If the account information is valid, then the gateway network server 120 sends, .e.g., via the API 121, a message to the end device 111 indicating that the account is valid, as depicted in step 206. On the other hand, if the account information is invalid, then the gateway network 120 sends a message to the end device 111 indicating that the account is invalid, as depicted in step 207. According to an embodiment, either one or both of the validity and invalidity messages can be first sent to the first payment network server 130 before they're transmitted to the end device 111. Then, after it is confirmed that the account associated with entity B is valid, the end 111 can proceed to send a desired amount of electronic currency to the account associated with entity B, as depicted in step 208. In this regard, the end device 111 can send a credit message to the first payment network server 130, as depicted in step 209. The first payment network server 130 can then send this credit message to the gateway network server 120, as depicted in the step 210. Then, the gateway network server 120 again checks if the account information associated with entity B is valid and eligible by querying the electronic date file in which the account information is stored, as depicted in step 211. Then, in step 212, the gateway network server 120 determines if the account information is valid. If the account information is valid, then the gateway network server 120 retrieves the debit card token associated with the account information, as depicted in step 213. On the other hand, if the account information is invalid, then the gateway network sends a message to the end device 111 indicating that the account is invalid, as depicted in step 207. Then, assuming the account information is valid, the gateway network server 120 sends a credit message for the debit card associated with the account to the second payment network 140, e.g., a debit push-to-card payment network, as depicted in step 214. The second payment network 140 then determines if the credit message for the debit card associated with the account is accepted, as depicted in step 215. In this regard, if the credit message is accepted, the second payment network 140 credits the desired currency to the account associated with entity B, as depicted in step 216. Further, the second payment network 140 can also send a message to the end device, e.g., via the first payment network server 130, indicating that the credit was accepted, as depicted in step 217. Otherwise, the second payment network 140 sends a message to the end device 111, e.g., via the first payment network server 130, indicating that the credit was not accepted.

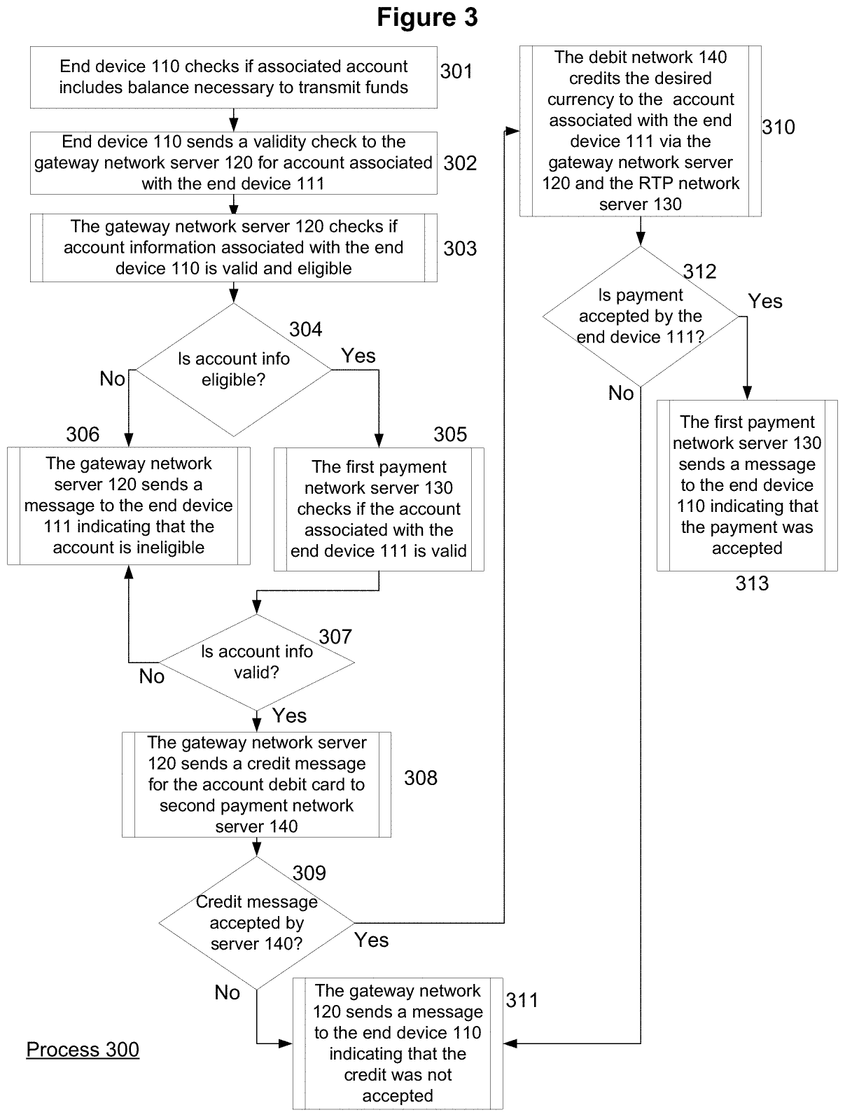

FIG. 3 depicts a flow diagram for the components in the system of FIG. 1 according to another exemplary embodiment of the invention. In particular, the figure depicts a process 300 for transmitting currency from an account associated with the entity B, e.g., the end device 110, to an account associated with the entity A, e.g., the end device 111. As depicted in step 301 of the figure, before entity B can send currency to entity A, the end device 111 must first check if the account associated with entity B (e.g., the end device 110) includes the balance necessary to transmit desired funds. After it is determined that the account associated with entity B has the required balance in the account, the end device 110 can send a validity check to the gateway network server 120 to determine the validity of the account associated with entity A, as depicted in step 302. In order to do this, the gateway network server 120 has to first check if the account information associated with the end device 110 is valid and eligible, e.g., by querying the stored electronic data file, as depicted in steps 303 and 304. In particular, the gateway network server 120 checks if the account associated with entity A is actually included in the stored electronic data file. If the account information associated with entity B is valid, then the first payment network server 130 checks to see if the account information associated with entity A is valid, as depicted in steps 305 and 307. On the other hand, if the account information is invalid, then the gateway network server 120 sends a message to the end device 111 indicating that the account is invalid/ineligible, as depicted in step 306. Further, if the first payment network server 130 determines that the account information associated with entity A is valid, then the gateway network server 120 sends a credit message to the second payment network 140 for a debit card associated with the entity B account, as depicted in step 308. If the first payment network server 130 determines that the account information associated with entity A is not valid, then the gateway network server 120 sends a message to the end device 111 indicating that the account is invalid, as depicted in step 306. In step 309, assuming the account information associated with entity A is valid, the second payment network 140 determines if the credit message was accepted. If the credit message is accepted, then the second payment network 140 credits the desired currency to the account associated with entity A via the gateway network server 120 and the first payment network server 130, as depicted in step 310. Otherwise, the gateway network server 120 sends a message to the end device 110 indicating that the payment was rejected, as depicted in step 311. Further, in step 312, the first payment network server 130 determines if the payment was accepted by the account associated with the end device 111. If the payment is accepted, then the first payment network server 130 sends a message to the end device 110, e.g., via the gateway network server 120, that the payment was accepted, as depicted in step 313. Otherwise, the first payment network 130 sends a message to the end device 110, e.g., via the gateway network server 120, that the payment was not accepted.

According to an embodiment, the processes 200 and 300 can also include additional controls (such as fraud check, validation, etc.), limits (e.g., ensuring only a certain amount is transferred per day), or failover options (such as sending the funds via another payment network, e.g., the Automated Clearing House (ACH) network and/or wire transfer, if the intended recipient account is not on the first payment network).

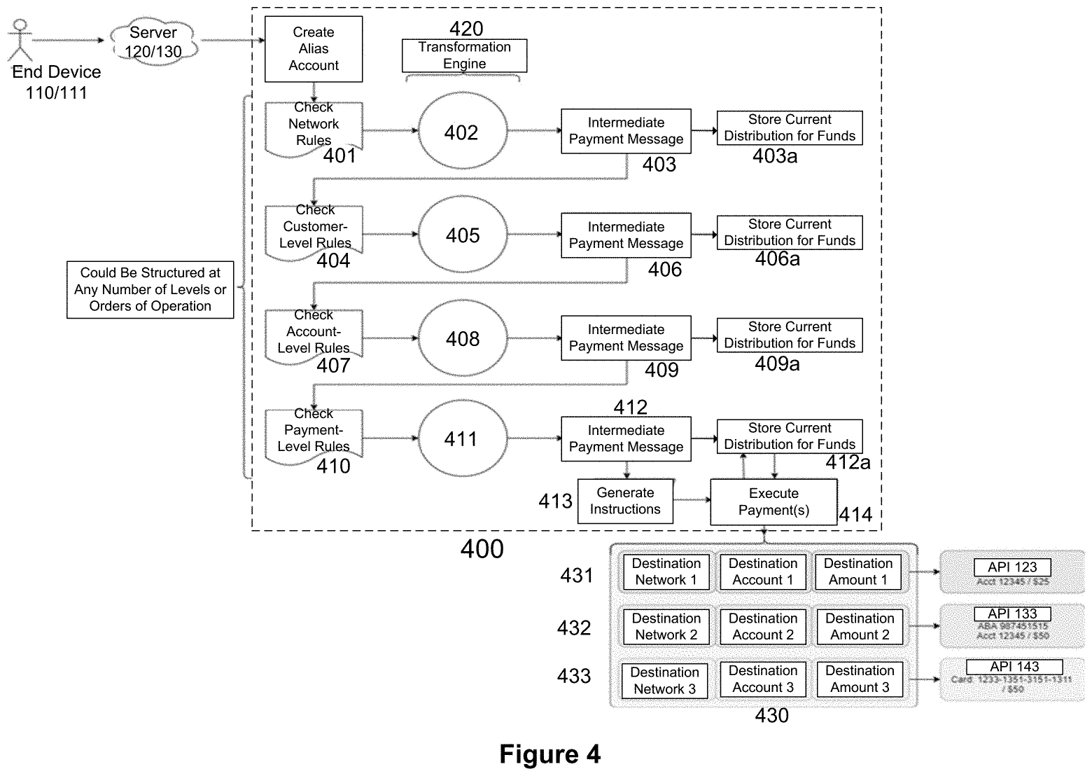

FIG. 4 depicts an interaction of the components in the system of FIG. 1 according to an exemplary embodiment of the invention. In particular, the figure depicts an interaction between the end devices 110/111, the network servers 120/130, and a computer-implemented software routing platform 400. According to an embodiment, the platform 400 can be implemented in at least one of the servers 120, 130, and 140 by at least one of the processors 122, 132, and 142, and can include at least one of APIs 123, 133, and 143. Further, according to another embodiment, the platform 400 can be implemented in at least one of the end devices 110/111, and can include at least one of the APIs associated with one of the end devices 110/111 (not shown). In this regard, the end device 110/111 can access one of the gateway network server 120 and the first payment network server 130 in order to send a desired amount of electronic currency, e.g., via the platform 400, to one of a plurality of destination accounts 430, e.g., an account 431 associated with the gateway network server 120, an account 432 associated with the first payment network server 130, and an account 433 associated with the second payment network server 140.

According to an embodiment, the platform 400 is configured to receive, e.g., via at least one of APIs 123, 133, and 143, an inbound message including the source account transmitting the electronic currency, a desired destination account 430, and the desired amount of electronic currency. In this regard, the inbound message can be based on one of SFTP, SOAP, JSON, and HTTPS Web Post. Further, each of the source account and the desired destination account 430 can include at least one of a payment network, routing number, and an account number, thereby creating a unique key for the source account and the destination account. In this regard, if the platform 400 determines that the source account and the destination account are associated with different payment networks, the platform 400 can create an alias/placeholder account for the source account which is based on the payment network associated with the destination account. For example, if the destination account is associated with the RTP network (which is generally a closed network), the platform 400 can create an alias account associated with the RTP network for the source account so that the destination account can receive the electronic currency. According to an embodiment, the created alias account can be stored in the inbound message. According to an embodiment, the platform 400 can also include a transformation engine 420 that can apply a series of cascading transformations (e.g., transformations 402, 405, 408, 411) to the inbound message that can be layered in an order of operation. According to an embodiment, the platform 400 performs a number of rule checks, e.g., network rule check 401, customer-level rule check 404, account level rule check 407, and payment-level rule check 410 (e.g., amount, sender, etc.), to ensure that the desired payment is valid for acceptance. According to an embodiment, the rules can be retrieved from a rules library, which can be stored on at least one of memories 121, 131, and 141, and/or memories associated with at least one of the end devices 110/111. In this regard, the rules 401, 404, 407, 410 can each contain a series of transformations (e.g., 402, 405, 408, 411, respectively) that are applied by the transformation engine 420. The transformations can be designed to be based on gated logic (e.g., if this, then that) and can contain a logical order. For example, account-level rule 407 can have a rule that if outbound message account is ‘12345’, the network is “RTP”, and the message notional value is over $100,000, then ‘split’ the payment between two messages to the same destination account, e.g., one of accounts 431, 432, and 433. This would allow the payment to be transmitted under the RTP network transaction limits (e.g., $100,000) and bypass a network rejection. The transformation engine can also logically substitute components of the message using the same logic. For example, customer-level rule 404 can contain instructions to modify the message to add an outbound message to allow funds to be immediately ‘bounced’ between payment networks. In this case, an inbound message on the RTP network for customer ‘ABC’ would immediately be transformed to an outbound message on another payment network, e.g., automated clearing house (ACH) network, with a destination alias account set to ‘ABC's’ operating account at an end device that does not support the RTP network. This is enabled by the transformation engine 420 working in conjunction with system 100, which can alias an account with multiple ‘pseudo’ account numbers. Further, although the rules 401, 404, 407, and 410 are notionally set up in a hierarchal execution order, they can be reordered within system 100 as desired. Each rule supports execution flow ‘tags’ to enable the transformation engine 420 to either immediately end the transformation, insert a pause (e.g., hold for 72 hours to ensure that an ACH payment is cleared), or wait for a specific event. For example, the payment-level rules 410 can specify that if a RTP payment is received on a non-business day, it cannot be ‘bounced’ to a wire transfer network until a window opens on the next business day at 8 AM EST. Further, network rules 401 can check if the system 100 either directly or through an alias has a record of an account contained in an inbound payment's destination account record. If it does, the platform 400 can continue processing the rules; if it does not, the platform 400 can reject the payment and end the rule flow execution. In this regard, according to another embodiment, the alias account can be created after the account-level rule check 410. Further, according to an embodiment, the transformations 402, 405, 408, and 411 can result in respective intermediate payment messages 403, 406, 409, 412, which can be used to track the distribution of funds between a variety of different general ledgers GLs, e.g., 403a, 406a, 409a, 412a. In particular, the platform 400 can store (e.g., in one of memories 121, 131, and 141) the intended distribution after each rule check and transformation so that any changes to the intended distribution can be tracked back to the particular rule check and/or transformation. For example, if the account-level rules 407 change after transformation 405 has been applied, a user is able to determine which rules in the account level rules 407 changed based on a comparison of the stored intended distributions of funds in 406a and the stored distribution of funds in 409a. Accordingly, the user is able to ensure that the eventual payment remains in balance with intended payment. Further, the transformations, which can be applied to the respective intermediate payment messages, can be stored within a single message, e.g., the intermediate payment message. According to an embodiment, once all of the transformations are completed, the platform 400 can generate individual payment instructions for the intermediate payment message, which can then be executed by the payment systems, e.g., RTP, debit push-to-card, etc., associated with destination accounts via the respective APIs 123, 133, and 143. In this regard, the individual payment instructions are provided to the one or more payment networks via the APIs 123, 133, and 143, as outbound messages. In this regard, the outbound messages can be sent to the one or more payment networks via the APIs 123, 133, and 143 via a variety of formats ranging from SFTP, SOAP APIs, JSON APIs, and HTTPS Web Post. Further, as depicted in the figure, the platform 400 provides the payment instructions based on the previously-stored intended distributions of funds in 412a.

According to an embodiment, the platform 400 can reference an external data provider (e.g., an external API) and transmit the referenced information to transformation engine 420 to use as part of the rule evaluation process. For example, assuming a client, e.g., via an end device 110/111, wants to participate in the authorization of an outgoing funds transaction (e.g., debit), the following can occur: the end device 110/111 exposes an API that accepts transaction information such as amount, debiting party, debiting account, and crediting account, wherein the end device 110/111 API can return a binary (e.g., allow or cancel) response; the customer-level rule 404 can include the end device 110/111 API details along with a specified wait time and a “fail open/fail closed” configuration (e.g., if the API does not response promptly, should the transaction be continued or canceled?); when an outgoing funds transaction is processed by the transformation engine 420, it can attempt to connect to the end device 110/111 API with the relevant transaction details and wait for a response; if the end device 110/111 API responds with “allow,” the transformation engine 420 can continue processing rules; if the end device 110/111 API responds with “cancel,” the transformation engine 420 can cancel the transaction; if the end device 110/111 API does not respond within the specified wait time and a “fail open” configuration is being implemented, then the transformation engine 420 can continue processing rules; and if the end device API 110/111 does not respond with the specified wait time and a “fail closed” configuration is being implemented, the transformation engine 420 will cancel the transaction.

Further, according to an embodiment, the rules and transformations could be structured with any number of levels or orders of operations. For example, the rules and transformations can be structured to send a short message service (SMS)/text message to an end device's 110/111 mobile telephone number asking which account a payment should be debited to. In this regard, the rules can be configured with an account-level rule 407 on a “master account” that specifies that any outgoing funds transaction needs to be funded from a list of internal accounts. The rules can also be configured with another account-level rule 407 that a text message be sent to end device 110/111 in order to determine which account should be used. Once a response from the end device 110/111 is received, the rule 407 can also specify that funds should be moved from the internal account to the master account and that the transaction can continue processing. For example, when an outgoing funds transaction is being processed by the transformation engine 420 on the master account, a text message can be sent to the end device 110/111 requesting a decision along with a list of options such as “Reply 1 for account 12345 or Reply 2 for account 45678.” If the end device 110/111 responds with “1,” then the transaction can be funded from account 12345. Accordingly, the transformation engine 420 can move the desired amount of funds from account 12345 into the master account. The transformation engine 420 can then continue to process the remainder of the rules. Further, according to an embodiment, the above-mentioned responses can be logged and stored in a database. As such, if there are any disputes about the transaction in the future, each step of the transaction can be reviewed as desired.

According to an embodiment, the platform 400 is capable of a large number of transformations between different networks, applying both schema and message formatting changes, applying layered logic (such as take an inbound payment and send a specific amount or percentage to specific payment network based on a factor of the inbound payment such as destination account, network type, or balance of an existing account). Further, according to an embodiment, the transformations can be cascading (e.g., A→B→C). According to another embodiment, the transformations can be tied together in a non-linear logic pattern, e.g., RTP →Account B→Check Value of Account C AND inbound network of RTP→Move to Debit else Store Value In Account B until further instruction.

According to an embodiment, the transformed message can be numerically identical to the original inbound payment (sum of inbound payments =sum of outbound payments). Further, the platform 400 can also transform an inbound account into a nominal equivalent. For example, an inbound account can be transformed into an outbound account, that can be further transformed into a physical debit card number, that can be further transformed into a tokenized card number to allow for posting to a debit push-to-card payment network.

As such, the platform 400 accept messages from one payment network and settle with a different payment network (or series of networks and accounts), or accept inbound payment messages (via methods previously described) on behalf of a financial institution, enterprise, business or consumer, and provide settlement and distribution through the same methods described above.

In the case of accepting outbound payments from a financial institution (such as a bank), the end device 110 could send an inbound message to send funds from a network that they are not currently a member of, such as the RTP network. The platform 400 could transform the inbound payment request (including the debiting/funding account from the end device 110) and debit the funds into an intermediate account on the platform's 400 core banking system using a debit payment method supported by the end device 110. The platform could then post the outbound payment to the requested network, and handle the intermediate funds movement and final settlement to the destination account. Using this method, a financial institution could offer a wide variety of payment services without building direct interfaces to all of them.

Further, according to an embodiment, the addition of new payment networks to the platform 400 can result in an exponential number of potential connections between the existing and new networks through the platform 400, e.g., (existing network+new network)^{(existing network+new network)}.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

The foregoing detailed description of the present disclosure is to be understood as being in every respect illustrative and exemplary, but not restrictive, and the scope of the present disclosure provided herein is not to be determined solely from the detailed description, but rather from the claims as interpreted according to the full breadth and scope permitted by patent laws. It is to be understood that the embodiments shown and described herein are merely illustrative of the principles addressed by the present disclosure and that various modifications may be implemented by those skilled in the art without departing from the scope and spirit of the present disclosure. Those skilled in the art may implement various other feature combinations without departing from the scope and spirit of the present disclosure. The various functional modules shown are for illustrative purposes only, and may be combined, rearranged and/or otherwise modified.

1. A computer-implemented system for transmitting electronic currency, the system comprising:
one or more processors, wherein the one or more processors are configured to:
receive an inbound message from a first end device associated with a first payment network, wherein the inbound message includes at least one of a source account, a destination account, and a desired amount of electronic currency to transmit;
upon determining that the destination account is associated with a second payment network, create an alias account for the source account based on the second payment network, wherein the second payment network is different from the first payment network;
apply one or more transformations to the inbound message to create an intermediate payment message, wherein the inbound message includes the alias account;
generate one or more payment instructions for the intermediate payment message; and
execute the one or more payment instructions with the second payment network.

2. The system of claim 1, wherein the first payment network is a real-time payment (RTP) network.

3. The system of claim 1, wherein the inbound message can be based on one of Secure File Transfer protocol (SFTP), Simple Object Access Protocol (SOAP), JavaScript Object Notation (JSON), and Hypertext Transfer Protocol Secure (HTTPS) Web Post.

4. The system of claim 1, wherein each of the source account and the destination account can include at least one of a payment network, routing number, and an account number.

5. The system of claim 1, wherein the applied transformations are cascaded.

6. The system of claim 1, wherein the one or more processors are further configured to:
apply one or more rule checks to the inbound message, wherein the one or more rule checks are applied before the one or more transformations are applied.

7. The system of claim 6, wherein the one or more rule checks include at least one of: a payment network rule check, a customer-level rule check, an account-level rule check, and a payment-level rule check.

8. The system of claim 1, wherein the one or more payment instructions are provided to the second payment network via an application programming interface (API).

9. The system of claim 1, wherein the one or more payment instructions are provided and executed by another payment network.

10. The system of claim 9, wherein the other payment network is a push-to-card payment network.

11. The system of claim 3, wherein the one or more applied transformation are stored within a single message.

12. A computer-implemented method for transmitting electronic currency, the method comprising:
receiving, with one or more processors, an inbound message from a first end device associated with a first payment network, wherein the inbound message includes at least one of a source account, a destination account, and a desired amount of electronic currency to transmit;
upon determining that the destination account is associated with a second payment network, creating, with the one or more processors, an alias account for the source account based on the second payment network, wherein the second payment network is different from the first payment network;
applying, with the one or more processors, one or more transformations to the inbound message to create an intermediate payment message, wherein the inbound message includes the alias account;
generating, with the one or more processors, one or more payment instructions for the intermediate payment message; and
executing, with the one or more processors, the one or more payment instructions with the second payment network.

13. The method of claim 12, wherein the first payment network is a real-time payment (RTP) network.

14. The method of claim 12, wherein the inbound message can be based on one of Secure File Transfer protocol (SFTP), Simple Object Access Protocol (SOAP), JavaScript Object Notation (JSON), and Hypertext Transfer Protocol Secure (HTTPS) Web Post.

15. The method of claim 12, wherein each of the source account and the destination account can include at least one of a payment network, routing number, and an account number.

16. The method of claim 12, wherein the applied transformations are cascaded.

17. The method of claim 12, further comprising:
applying, with the one or more processors, one or more rule checks to the inbound message, wherein the one or more rule checks are applied before the one or more transformations are applied.

18. The method of claim 17, wherein the one or more rule checks include at least one of: a payment network rule check, a customer-level rule check, an account-level rule check, and a payment-level rule check.

19. The method of claim 12, wherein the one or more payment instructions are provided to the second payment network via an application programming interface (API).
